(19) United States
(12) Patent Application Publication
(10) Pub. No.: US 2026/0003812 A1
(43) Pub. Date: Jan. 1, 2026

(54) TOPOLOGICAL CIRCUIT, ARTIFICIAL INTELLIGENCE CHIP AND DATA TRANSMISSION METHOD

(71) Applicant: Shenzhen Corerain Technologies Co., Ltd, Shenzhen (CN)

(72) Inventors: Jiadong WANG, Shenzhen (CN); Kuen Hung TSOI, Shenzhen (CN); Xinyu NIU, Shenzhen (CN)

(73) Assignee: Shenzhen Corerain Technologies Co., Ltd, Shenzhen (CN)

(21) Appl. No.: 19/207,574

(22) Filed: May 14, 2025

(30) Foreign Application Priority Data
Jun. 28, 2024 (CN) 202410866327.0

(51) Int. Cl. G06F 13/36

(52) U.S. Cl. CPC G06F 13/36; G06F 2213/40

(57) ABSTRACT

A topological circuit, an artificial intelligence chip, and a data transmission method, which relate to the field of artificial intelligence, are proposed. The topological circuit includes: a controller that sends a first control signal; N node devices, which are respectively connected to the controller and connected in a ring through a bus to form a loop. The N node devices include: a first node device, configured to convert the first control signal into a bus signal and transmit the bus signal along the loop in response to receiving the first control signal, the bus signal includes a transmission option and a broadcast indicator, the transmission option is a read transmission or a write transmission; N-1 second node devices, each second node device is configured to perform a corresponding operation according to the bus signal in response to receiving the bus signal.

### CROSS-REFERENCE TO RELATED APPLICATIONS

The present application claims priority to Chinese patent application No. 202410866327.0, filed on Jun. 28, 2024, and entitled “Topological circuit, artificial intelligence chip and data transmission method”, which is incorporated herein by reference in its entirety.

### TECHNICAL FIELD

The present application relates to the field of artificial intelligence, and particularly to a topological circuit, an artificial intelligence chip and a data transmission method.

### BACKGROUND

A conventional interconnection architecture is a mesh topological architecture based on a bus, that is, buses of all devices are connected to a public internet network. The mesh topological architecture based on the bus has problems, such as 1) a need to convert a clock domain, 2) device contention, and 3) path contention.

In the related art, to solve the problems of the mesh topological architecture based on the bus, a ring topological architecture is proposed.

### SUMMARY

According to one aspect of embodiments of the present application, a topological circuit is proposed, comprising: a controller, configured to send a first control signal; and N node devices, respectively connected to the controller, N>2, the N node devices are connected in a ring via a bus to form a loop, and the N node devices include: a first node device, configured to: convert the first control signal into a bus signal in response to receiving the first control signal, and transmit the bus signal along the loop, the bus signal comprises a transmission type and a broadcast indicator, the transmission type is one of a read transmission and a write transmission, the broadcast indicator comprises N flag bits corresponding to the N node devices one by one, each flag bit has a first value or a second value, the first value indicates that a data operation corresponding to the transmission type needs to be performed, and the second value indicates that the data operation does not need to be performed, and N-1 second node devices, each second node device is configured to perform a corresponding operation according to the bus signal in response to receiving the bus signal.

According to some embodiments of the present application, the bus signal further comprises a transmission mode and a destination identifier, the transmission mode is a first transmission mode corresponding to the destination identifier or a second transmission mode corresponding to the broadcast indicator; and each second node device is configured to perform a corresponding operation according to the transmission mode in response to receiving the bus signal.

According to some embodiments of the present application, each second node device is configured to: if the transmission mode is the first transmission mode, verify whether the destination identifier corresponds to itself, if the destination identifier corresponds to itself, perform the data operation; if the destination identifier does not correspond to itself, transmit the bus signal along the loop to the next second node device.

According to some embodiments of the present application, each second node device is configured to: if the transmission mode is the second transmission mode, verify a value of a flag bit corresponding to itself; if a value of a flag bit corresponding to itself is the first value, perform the data operation, and after changing the value of the flag bit corresponding to itself to the second value, transmit the bus signal along the loop to a next second node device; if a value of a flag bit corresponding to itself is the second value, when the value of at least one of the N flag bits is the first value, transmit the bus signal along the loop to a next second node device.

According to some embodiments of the present application, each second node device is configured to: when all the N flag bits are the second value, stop transmitting the bus signal.

According to some embodiments of the present application, further comprising: one or more groups of selectors, one group of selectors corresponds to one node device, at least one group of selectors includes a first subgroup of selectors, and the first subgroup of selectors is configured to control whether the bus signal transmitted along a first direction skips a corresponding node device.

According to some embodiments of the present application, the loop is a bidirectional loop, at least one group of selectors includes a second subgroup of selectors, and the second subgroup of selectors is configured to control whether the bus signal along a second direction skips the corresponding node device, and the second direction is different from the first direction.

According to some embodiments of the present application, at least one group of the selectors includes the first subgroup of selectors and the second subgroup of selectors.

According to some embodiments of the present application, the first subgroup of selectors and the second subgroup of selectors each include a first selector and a second selector, in each subgroup of selectors: the first selector comprises: a first input terminal, connected to a former node device of the corresponding node device, a first output terminal, connected to the corresponding node device, and a second output terminal; the second selector comprises: a second input terminal, connected to the second output terminal, a third input terminal, connected to the corresponding node device, and a third output terminal, connected to a latter node device of the corresponding node device.

According to some embodiments of the present application, the one or more groups of selectors include N groups of selectors.

According to some embodiments of the present application, the controller is further configured to: send a second control signal to each group of selectors to control each group of selectors to control whether the bus signal skips the corresponding node device.

According to some embodiments of the present application, the first subgroup of selectors corresponding to a specific node device among the N node devices are configured to control the bus signal transmitted along the first direction to skip the specific node device, and the specific node device includes a faulty node device or a node device shut down.

According to some embodiments of the present application, the loop is a bidirectional loop, and the first node device is configured to: when the transmission mode is the first transmission mode, determine a length of a first path and a length of a second path from the first node device to a target node device corresponding to the destination identifier via a first direction and a second direction respectively; if the length of the first path is less than the length of the second path, transmit the bus signal along the first direction; if the length of the first path is greater than the length of the second path, transmit the bus signal along the second direction.

According to some embodiments of the present application, the loop is a bidirectional loop, and the first node device is configured to: on condition that the transmission mode is the second transmission mode, determine a third path with the shortest length among all paths from the first node device to all second node devices corresponding to a flag bit whose value is the first value via a first direction and a second direction respectively; and transmit the bus signal along the third path.

In some embodiments, each second node device is configured to: on condition that the transmission mode is the second transmission mode, verify a value of a flag bit corresponding to itself; if the value of the flag bit corresponding to itself is the first value, perform the data operation, and after changing the value of the flag bit corresponding to itself to the second value, determine a fourth path with the shortest length among all paths from itself to all second node devices corresponding to a flag bit whose value is the first value via the first direction and the second direction respectively, and transmit the bus signal to a next second node device along the fourth path; and if the value of the flag bit corresponding to itself is the second value, when a value of at least one flag bit among the N flag bits is the first value, transmit the bus signal to a next second node device along the same direction as a direction in which the bus signal was received.

According to some embodiments of the present application, the loop is a bidirectional loop, and the first node device is configured to: on condition that the transmission mode is the second transmission mode, determine a first sum of lengths of all paths via a first direction from the first node device to all second node devices corresponding to a flag bit whose value is the first value, and a second sum of lengths of all paths via a second direction from the first node device to all second node devices corresponding to a flag bit whose value is the first value; if the first sum is less than the second sum, transmit the bus signal along the first direction; and if the first sum is greater than the second sum, transmit the bus signal along the second direction; and the second node device is configured to: transmit the bus signal along the same direction as a direction in which the bus signal is received, when transmitting the bus signal along the loop to a next second node device.

According to some embodiments of the present application, the controller is a general-purpose processor, and the N node devices are accelerated processors.

According to another aspect of embodiments of the present application, an artificial intelligence chip is proposed, including a topological circuit of any of the above embodiments.

According to another aspect of embodiments of the present application, a data transmission method based on a topological circuit of any of the above embodiments is proposed, comprising: the controller sends the first control signal; in response to receiving the first control signal, the first node device converts the first control signal into a bus signal, and transmits the bus signal along the loop; and in response to receiving the bus signal, each second node device performs a corresponding operation according to the bus signal.

### BRIEF DESCRIPTION OF THE DRAWINGS

The accompanying drawings constitute a part of the present description, which describe illustrated embodiments of the present application and are used together with the present description to explain principles of the present application.

With reference to the accompanying drawings, the present application can be more clearly understood according to the detailed description below, and in the accompanying drawings:

FIG. 1 illustrates a schematic diagram of a topological circuit according to some embodiments of the present application.

FIG. 2 illustrates a schematic diagram of a topological circuit according to some other embodiments of the present application.

FIG. 3 illustrates a schematic diagram of a topological circuit according to other embodiments of the present application.

FIG. 4 illustrates a schematic diagram of a node device and its corresponding set of selectors according to some embodiments of the present application.

It should be understood that the same or similar reference numbers represent the same or similar components.

### DESCRIPTION OF EMBODIMENTS

Various illustrated embodiments of the present application will now be described in detail with reference to the accompanying drawings. The description of the illustrated embodiments is merely illustrative and is by no means intended to limit the present application and its application or use. The present application can be implemented in many different forms and is not limited to the embodiments described herein. These embodiments are provided to make the present application thorough and complete and to fully convey the scope of the present application to those skilled in the art. It should be noted that unless otherwise specified, the relative arrangement of components and steps, composition of materials, numerical expressions and values described in these embodiments should be interpreted as merely exemplary and not as limiting.

The words “first”, “second” and similar words used in the present application do not indicate any order, quantity or importance, but are only used to distinguish different parts. Words such as “include” or “comprise” mean that the elements before the word include the elements listed after the word, and do not exclude the possibility of also including other elements. “Up”, “down” and the like are only used to indicate relative positional relationships. When the absolute position of the described object changes, the relative positional relationship may also change accordingly.

In the present application, when a specific component is described as being located between a first component and a second component, there may or may not be an intermediate component between the specific component and the first component or the second component. When a specific component is described as being connected to other components, the specific component may be directly connected to the other components without an intermediate component, or may not be directly connected to the other components but have an intermediate component.

All terms (including technical terms or scientific terms) used in the present application have the same meaning as understood by ordinary technicians in the field to which the present application belongs, unless otherwise specifically defined. It should also be understood that terms defined in general dictionaries, for example, should be interpreted as having a meaning consistent with their meaning in the context of the relevant technology, and should not be interpreted in an idealized or extremely formal sense, unless explicitly defined as such here.

The technologies, methods and devices known to ordinary technicians in the relevant field may not be discussed in detail, but where appropriate, the technologies, methods and devices should be considered as part of the application.

In the context of the rapid development of artificial intelligence today, the amount of data required for calculation (including parameters, input data) is usually very large. In order to improve computing performance and efficiency, data is usually transmitted in parallel, that is, multiple chips or multiple modules within the same chip use the same parameters, models, etc. to calculate different data in parallel.

The inventors note that in the above context, there are still some problems with the ring topological architecture. For example, if multiple devices need to share data, the party initiating the data transmission needs to go through multiple data transmissions before the data can be transmitted to each destination in turn, which affects the data transmission efficiency.

In view of this, the following technical solutions are proposed in the embodiments of the present application, which contributes to improve the data transmission efficiency.

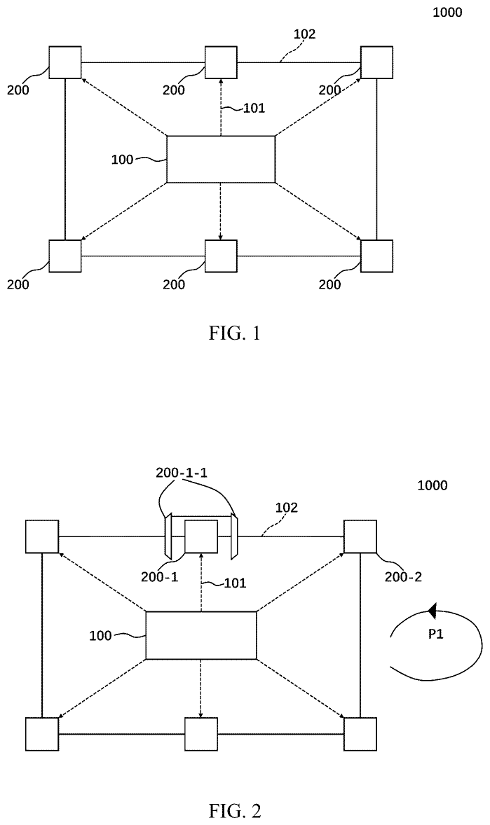

FIG. 1 illustrates a schematic diagram of a topological circuit according to some embodiments of the present application.

As shown in FIG. 1, the topological circuit 1000 includes a controller 100 and N node devices 200, where N>2. It should be understood that N is an integer. The controller 100 is configured to send a first control signal 101, and the N node devices 200 are connected in a ring via a bus to form a loop. The N node devices include a first node device and N-1 second node devices. Here, the node device that receives the first control signal 101 is referred to as the first node device, and the other node devices are referred to as the second node device.

The first node device is configured to: in response to receiving the first control signal 101, convert the first control signal into a bus signal 102, and transmit the bus signal 102 along the loop.

The bus signal 102 comprises a transmission option (op) and a broadcast indicator (indicator). The transmission option is one of a read transmission and a write transmission. For example, the transmission option is a read transmission; for another example, the transmission option is a write transmission, in which case the bus signal 102 also comprises data to be written. It should be noted that, in this application, broadcast may also be referred to as multicast.

The broadcast indicator comprises N flag bits corresponding to N node devices 200 one by one, and a value of each flag bit is a first value or a second value, the first value indicates that a data operation corresponding to the transmission option needs to be performed, and the second value indicates that the data operation does not need to be performed.

Each second node device is configured to: in response to receiving the bus signal 102, perform a corresponding operation according to the bus signal 102. The corresponding operation includes one of reading data and writing data, or continuing to transmit the bus signal 102, which will be described in detail below.

It should be understood that the difference between the first node device and the second node device is that the first node device is used to receive the first control signal 101 sent by the controller 100, and the second node device is used to receive the bus signal 102 sent by the first node device, and the two perform different tasks. A node device is the first node device in some cases while the second node device in other cases.

The first value and the second value are only used to distinguish each other, and different implementation methods can be adopted.

As an implementation method, each of the first value and the second value is a fixed value. For example, the first value is 1 and the second value is 0; or, the first value is 0 and the second value is 1.

As another implementation, the first value and the second value are both values in a certain set. For example, the first value is any number in {0,2,4,6,8}, and the second value is any number in {1,3,5,7,8}; or vice versa.

As another implementation, the first value and the second value are both values in a certain interval. For example, the first value is any number in the interval [0,5], and the second value is any number in the interval (5,10]; or vice versa.

In some cases, the value types of the first value and the second value can also be different types of fixed values, values in a set, and values in an interval. For example, the first value is a fixed value, the second value is any number in a certain set, and so on. Various value methods are not repeated here.

The broadcast indicator is used to inform each second node device whether to perform the corresponding data operation. By adding a broadcast indicator to the bus signal 102, for example, a value of M flag bits in the broadcast indicator is the first value (hereinafter, M represents a number of second device nodes that need to be broadcast), M<N, it is only necessary to send the bus signal 102 once to achieve the purpose of specifically commanding the corresponding M second node devices to perform the corresponding tasks, while other second node devices do not perform them, thereby improving the efficiency of information transmission and task execution. For example, if the task to be performed is to write data, the first node device can make the above-mentioned M second node devices write the same data by only transmitting the bus signal 102 once, quickly realizing data sharing and improving data transmission efficiency.

In some embodiments, the bus signal 102 also includes a transmission mode (mode) and a destination identifier (dst_id), and the transmission mode is a first transmission mode corresponding to the destination identifier or a second transmission mode corresponding to the broadcast indicator. In this case, each second node device is configured to respond to receiving the bus signal 102 and perform corresponding operations according to the transmission mode.

Although the broadcast indicator can solve the problem of data sharing in one data transmission, there is still a need for point-to-point data transmission. By setting the transmission mode and distinguishing the transmission mode into a first transmission mode (such as a point-to-point transmission mode) and a second transmission mode (such as a data broadcast mode), it is possible to achieve the desired effect without changing the form of the bus signal 102. It has two data transmission functions at the same time. In this way, it can adapt to the needs of more scenarios and improve the application scope of the topological circuit 1000.

In some embodiments, the bus signal 102 also includes a data size (size) and a source identifier (src_id) to determine the size of the amount of data to be transmitted and to inform the second node device of the initiator of the bus signal 102. For example, when the transmission option is a read transmission, the corresponding second node device can verify that the data needs to be transmitted to the first node device according to the source identifier and can verify the amount of data to be transmitted each time according to the data size. For another example, when the transmission option is a write transmission, the corresponding second node device can verify that the source of the data is the first node device according to the source identifier and can verify the size of the amount of data written.

In some embodiments, the bus signal 102 also includes a target offset address (addr) to determine which address the data is specifically stored in the device after it arrives at the target node device. For example, in the case of point-to-point transmission, when the transmission option is a write transmission or a read transmission, the target node device (the corresponding second node device) writes the data to itself or reads it from itself according to the target offset address. For another example, in the case of broadcasting write data, the bus signal 102 includes M target offset addresses, and correspondingly, the corresponding M second node devices write data into themselves according to their respective target offset addresses.

In some embodiments, each second node device is configured to: if the transmission mode is the first transmission mode (point-to-point transmission), verify whether the destination identifier corresponds to itself. If the destination identifier corresponds to itself, perform data operations; if the destination identifier does not correspond to itself, transmit the bus signal 102 along the loop to the next second node device. It should be noted that in this article, the next second node device of a second node device is a second node device adjacent to the second node device, that is, transmitting along the loop to the next second node device includes continuing to transmit to the next second node device along the direction in which the bus signal 102 is received, and also includes transmitting to the next second node device along another direction different from the direction in which the bus signal 102 is received. In this case, the position of the next second node device relative to the second node device is not fixed and depends on the direction of the transmission bus signal 102.

By verifying whether the destination identifier corresponds to itself, it can be determined whether it is a second node device that needs to perform data operations, thereby accurately performing data transmission tasks. If not, the bus signal 102 continues to be transmitted. When the target node device is too far away from the first node device (i.e., there is at least one other second node device in between), it acts as an intermediary station for data transmission. In this way, data mis-transmission can be prevented, making data transmission more efficient.

In some embodiments, each second node device is configured to: if the transmission mode is the second transmission mode (broadcast transmission), verify the value of the flag bit corresponding to itself; if the value of the flag bit corresponding to itself is the first value, perform data operation, and after changing the value of the flag bit corresponding to itself to the second value, transmit the bus signal 102 along the loop to the next second node device; if the value of the flag bit corresponding to itself is the second value, when the value of at least one flag bit among the N flag bits is the first value, transmit the bus signal 102 along the loop to the next second node device.

By verifying whether the value of the flag bit corresponding to itself is the first value, it can be determined whether it is one of the M second node devices that need to share data, thereby accurately performing the data transmission task.

If it needs to perform data operations, it changes the value of the flag bit corresponding to itself to the second value and transmits the bus signal 102 along the loop to the next second node device, so as to avoid the situation where the same operation needs to be performed again if the bus signal 102 is received again, thereby reducing unnecessary time consumption and improving data transmission efficiency. At the same time, as described below, changing the value of its own flag bit also helps other second node devices determine whether to stop transmitting the bus signal 102, thereby avoiding an infinite loop in data transmission.

If it does not need to perform data operations, when there are other flag bits with the first value, the bus signal 102 is transmitted along the loop to the next second node device, thereby avoiding data transmission failure and ensuring that all M second node devices are broadcasted.

In some embodiments, each second node device is configured to stop transmitting the bus signal 102 when all N flag bits are the second value. At this time, all M second node devices have received the broadcast and do not need to continue transmitting the bus signal 102. In this way, the infinite loop of the bus signal 102 on the loop can be effectively avoided.

The inventor also noted that there are other problems with the ring topological architecture of the related art. For example, when a node in the loop fails, it will have a serious impact on the entire loop. For another example, due to reasons such as excessive power consumption, it is necessary to shut down one or some nodes. When the loop is a unidirectional loop, all transmission paths passing through the faulty node or the node shut down become unusable. When the loop is a bidirectional loop, although the faulty node or the node shut down can be bypassed by changing the transmission direction, the transmission efficiency may be significantly reduced due to the lengthening of the path.

In some embodiments, the topological circuit 1000 proposed in the present application also includes: one or more groups of selectors, one group of selectors corresponding to one node device 200. At least one group of selectors includes a first subgroup of selectors, and the first subgroup of selectors is configured to control whether the bus signal 102 transmitted along the first direction P1 skips the corresponding node device. Here, a group of selectors corresponding to a node device 200 means that a group of selectors corresponds to only one node device 200 and one node device 200 corresponds to only one group of selectors, that is, one or more groups of selectors correspond to one or more node devices one by one.

FIG. 2 illustrates a schematic diagram of a topological circuit according to some other embodiments of the present application.

As shown in FIG. 2, for convenience, different node devices 200 are distinguished by node device 200-x, and different x represents different node devices, and the same applies to the following text.

As an example, the node device 200-1 has a corresponding set of selectors. The set of selectors includes a first subgroup of selectors 200-1-1 (for convenience, the first subgroup of selectors is represented as the first subgroup of selectors 200-x-1, and the second subgroup of selectors is represented as the second subgroup of selectors 200-x-2, and the meaning of x is the same as x above).

It should be understood that although not shown in FIG. 2, other node devices may also have a set of selectors. In addition, the first direction P1 is shown in FIG. 2 as a counterclockwise manner, but this is not restrictive. In some embodiments, the first direction P1 may also be a clockwise direction.

When the node device 200-1 fails or needs to be shut down for reasons such as saving power consumption, if there is a bus signal 102 sent by the adjacent node device 200-2 to the node device 200-1 along the first direction P1, the bus 102 is usually unable to transmit. At this time, the first subgroup of selectors 200-1-1 of the node device 200-1 is set to make the bus signal 102 transmitted in the first direction P1 skip the node device 200-1, so that even if the node device 200-1 is actively shut down or cannot work, the topological circuit 1000 can work normally. In this way, the topological circuit 1000 can adapt to the above unexpected situations and improve the scope of application.

In some embodiments, the loop is a bidirectional loop, at least one group of selectors includes a second subgroup of selectors, and the second subgroup of selectors is configured to control whether the bus signal 102 along the second direction P2 skips the corresponding node device, and the second direction P2 is different from the first direction P1.

As some implementations of the bidirectional loop, there may be two groups of buses between two adjacent node devices 200 (if a node device 200-x has a subgroup of selectors, the bus is connected to the subgroup of selectors of the node device 200-x rather than the node device 200-x itself), for transmitting the bus signal 102 along the first direction P1 and the second direction P2. That is, each node device 200 is configured with a total of 4 groups of buses.

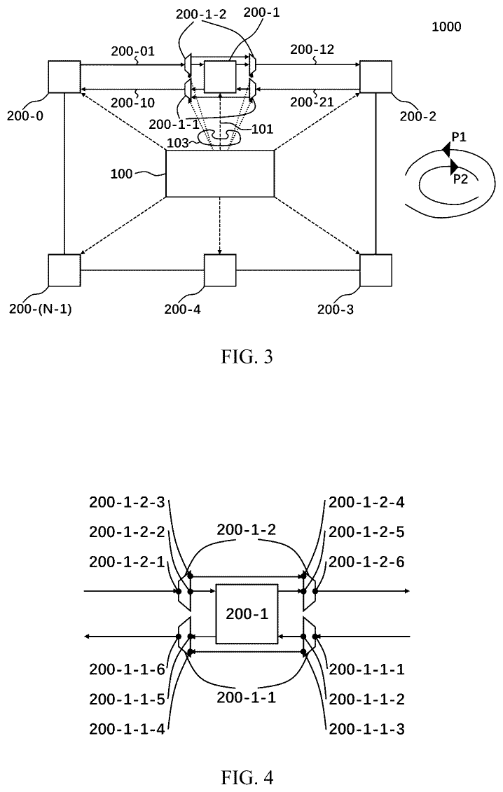

FIG. 3 illustrates a schematic diagram of a topological circuit according to other embodiments of the present application. FIG. 3 shows node devices 200-0, 200-1, 200-2, 200-3, 200-4 and 200-(N-1).

As shown in FIG. 3, as an example, the node device 200-1 has 4 groups of buses: a first bus 200-12, a second bus 200-21, a third bus 200-10 and a fourth bus 200-01, which are respectively used to transmit a bus signal 102 to a latter node device 200-2, receive a bus signal 102 from the latter node device 200-2, transmit a bus signal 102 to a former node device 200-0, and receive a bus signal 102 from the former node device 200-0.

Still referring to FIG. 3, as an example, the selector of the node device 200-1 also includes a second subgroup of selectors 200-1-2. It should be understood that the node device 200 with the second subgroup of selectors is not necessarily the same as the node device 200 with the first subgroup of selectors. For example, one node device 200 has a corresponding first subgroup of selectors 200-1-1, and the other node device 200 has a corresponding second subgroup of selectors 200-1-2.

When the node device 200-1 fails or needs to be shut down for reasons such as saving power consumption, if there is another adjacent node device 200-0 sending a bus signal 102 to the node device 200-1 along the second direction P2, the bus 102 is usually unable to transmit. At this time, the second subgroup of selectors 200-1-2 of the node device 200-1 is set so that the bus signal 102 transmitted in the second direction P2 skips the node device 200-1, so that even if the node device 200-1 is actively shut down or cannot work, the topological circuit 1000 can work normally. In this way, the topological circuit 1000 can also adapt to the above-mentioned unexpected situations, further improving the scope of application.

In some embodiments, at least one group of selectors includes a first subgroup of selectors and a second subgroup of selectors.

Still taking FIG. 3 as an example, the node device 200-1 has both a first subgroup of selectors 200-1-1 and a second subgroup of selectors 200-1-2. At this time, when the node device 200-1 fails or is shut down, the bus signal 102 from either the node device 200-0 or the node device 200-2 can skip the node device 200-1 and continue to be transmitted. In particular, in the case where the bus signal can be transmitted in two different directions at the same time in a bidirectional loop, the failure of the node device 200-0 to work at this time will still not affect the performance of the entire topological circuit 1000, thus further improving the scope of application.

In some embodiments, the first subgroup of selectors and the second subgroup of selectors both include a first selector and a second selector. In each subgroup of selectors, the first selector includes: a first input terminal connected to the former node device of the corresponding node device, a first output terminal connected to the corresponding node device, and a second output terminal. In each subgroup of selectors, the second selector includes a second input terminal connected to the second output terminal, a third input terminal connected to the corresponding node device, and a third output terminal connected to the next node device of the corresponding node device. Here, the connection with the former node device/latter node device of the corresponding node device can refer to a direct connection when the former node device/latter node device does not have a corresponding subgroup of selectors and can also refer to an indirect connection through a port of the subgroup of selectors when the former node device/latter node device has a corresponding subgroup of selectors.

FIG. 4 illustrates a schematic diagram of a node device and its corresponding set of selectors according to some embodiments of the present application.

As shown in FIG. 4, taking the node device 200-1 as an example, if it is not working, the corresponding first subgroup of selectors 200-1-1 and the second subgroup of selectors 200-1-2 are respectively set to make the bus signal 102 along the first direction P1 and the second direction P2 skip the node device 200-1 itself, and vice versa. The first subgroup of selectors 200-1-1 includes a first selector on the right and a second selector on the left, and the second subgroup of selectors 200-1-2 includes a first selector on the left and a second selector on the right.

If the first subgroup of selectors 200-1-1 is set to skip the node device 200-1, when the bus signal 102 transmitted along the first direction P1 reaches the first input terminal 200-1-1-1 of the first selector, the bus signal 102 is controlled to be output from the second output terminal 200-1-1-3 of the first selector, then reaches the second input terminal 200-1-1-4 of the second selector, and finally outputs from the third output terminal 200-1-1-6 of the second selector. In the whole process, the bus signal 102 does not pass through the node device 200-1.

If the first subgroup of selectors 200-1-1 is set not to skip the node device 200-1, when the bus signal 102 transmitted along the first direction P1 reaches the first input terminal 200-1-1-1 of the first selector, the bus signal is controlled to be output from the first output terminal 200-1-1-2 of the first selector, and then reaches the inside of the node device 200-1.

The node device 200-1 determines that the bus signal 102 does not need to be processed (for example, the transmission mode is the first transmission mode and the destination identifier does not correspond to itself, or the transmission mode is the second transmission mode and the value of the flag bit corresponding to itself is the second value), then the bus signal 102 is output to the third input terminal 200-1-1-5, and finally output from the third output terminal 200-1-1-6.

The node device 200-1 determines that the bus signal 102 needs to be processed (for example, the transmission mode is the first transmission mode and the destination identifier corresponds to itself, or the transmission mode is the second transmission mode and the value of the flag bit corresponding to itself is the first value), then the bus signal 102 is processed. Then, depending on whether the transmission needs to continue (for example, the transmission mode is the second transmission mode and there are other flag bits with the first value), it is decided whether to output the bus signal 102 to the third input terminal 200-1-1-5 of the second selector, and finally output from the third output terminal 200-1-1-6 of the second selector. During the whole process, the bus signal 102 passes through the node device 200-1.

In the second subgroup of selectors 200-1-2, the first input terminal 200-1-2-1 of the first selector, the first output terminal 200-1-2-2 of the first selector, the second output terminal 200-1-2-3 of the first selector, the second input terminal 200-1-2-4 of the second selector, the third input terminal 200-1-2-5 of the second selector and the third output terminal 200-1-2-6 of the second selector work in the same manner as the corresponding terminals of the first subgroup of selectors 200-1-1, and will not be described again here.

It is only necessary to configure the first input terminal, the first output terminal, the second output terminal, the second input terminal, the third input terminal and the third output terminal for each subgroup of selectors, so that each subgroup of selectors can easily control whether the bus signal 102 is skipped or not. In this way, the topological circuit 1000 can have better performance without overly complicating each device.

In some embodiments, the topological circuit 1000 has N groups of selectors, that is, each node device 200 has a corresponding group of selectors. In this way, the topological circuit 1000 can realize normal data transmission when any node device 200 is not working, thereby giving the topological circuit 1000 a better ability to adapt to unexpected situations.

Further, on the basis that each node device 200 has a group of selectors, each group of selectors also has a first subgroup of selectors and a second subgroup of selectors. In this way, the ability of the topological circuit 1000 to adapt to unexpected situations can be further improved.

In some embodiments, as shown in FIG. 3, the controller 100 is also configured to: send a second control signal 103 (a dotted line surrounded by a closed curve in FIG. 3) to each group of selectors to control each group of selectors to control whether the bus signal skips the corresponding node device.

As some implementations, the second control signal 103 may include a first control sub-signal and a second control sub-signal, the control values of the first control sub-signal and the second control sub-signal are the third value or the fourth value, and the first subgroup of selectors and the second subgroup of selectors respectively determine whether to skip the bus signal 102 according to the control values of the first control sub-signal and the second control sub-signal.

Taking the first subgroup of selectors as an example, the first subgroup of selectors verifies the control value of the first control sub-signal in response to receiving the first control sub-signal.

If the control value is the third value, the bus signal 102 from the first direction P1 skips the corresponding node device 200; if the control value is the fourth value, the bus signal 102 from the first direction P1 does not skip the corresponding node device 200.

The processing method of the second subgroup of selectors after receiving the second control signal is similar to that of the first subgroup of selectors, from which it is distinguished by whether the bus signal 102 from the second direction P2 skips the corresponding node device 20, which will not be repeated here.

The distinction between the third value and the fourth value can refer to the above-mentioned method for distinguishing the first value and the second value, which will not be repeated here.

By configuring the second control signal 103, in the simplest case, only a 2-bit signal is required for each node device 200 (that is, 2 bits control two subgroups of selectors of the node device 200 respectively), so as to realize the control of whether the node device 200 skips the bus signal 102. In this way, the functionality of the topological circuit 1000 can be increased without significantly increasing quantity of signals.

In some embodiments, the first subgroup of selectors corresponding to a specific node device among the N node devices 200 is configured to control the bus signal 102 transmitted along the first direction P1 to skip the specific node device, and the specific node device includes a faulty node device or a node device shut down.

When the node device 200 fails or is shut down, the first subgroup of selectors of the node device 200 is set to skip the bus signal 102 transmitted along the first direction P1. In this way, the failure or shutdown of the node device 200 can be realized without perception, ensuring the normal operation of the entire topological circuit 1000. For example, after the topological circuit 1000 is manufactured, if a node device 200 is found to have a fault, the first subgroup of selectors corresponding to the node device 200 can be controlled to make the bus signal 102 transmitted along the first direction P1 fixedly skip the node device 200.

In some embodiments, the second subgroup of selectors corresponding to the specific node device among the N node devices 200 is configured to control the bus signal 102 transmitted along the second direction P2 to skip the specific node device. In this way, the normal operation of the entire topological circuit 1000 can be more effectively ensured.

In some embodiments, the loop of the topological circuit 1000 is a bidirectional loop, and the first node device is configured to: when the transmission mode is the first transmission mode, determine the length of the first path and the length of the second path from the first node device to the target node device corresponding to the destination identifier via the first direction P1 and the second direction P2 respectively; if the length of the first path is less than the length of the second path, transmit the bus signal 102 along the first direction P1; if the length of the first path is greater than the length of the second path, transmit the bus signal 102 along the second direction P2.

As some implementations, the number of node devices 200 in the first path and the second path can be determined and used as the length of the first path and the second path. In this case, the path segments between all adjacent node devices 200 in the loop can be regarded as equivalent.

As other implementations, when the path segments between adjacent node devices 200 in the loop are not equivalent (that is, the corresponding actual physical length is longer or other factors), a corresponding weight can be assigned to each path segment, and the weights of all path segments in the first path and the second path are determined and summed and used as the length of the first path and the second path.

Thus, in the case of point-to-point transmission, the first node device performs path optimization, that is, finds a shorter path to transmit the bus signal 102 to the target node device, which can further effectively improve the efficiency of data transmission.

In some embodiments, the loop of the topological circuit 1000 is a bidirectional loop, and the first node device is configured to: when the transmission mode is the second transmission mode, determine the shortest third path among all paths from the first node device to all second node devices corresponding to the flag bit with the first value via the first direction P1 and the second direction P2 respectively; transmit the bus signal 102 along the third path.

In some embodiments, each second node device is configured to: verify the value of the flag bit corresponding to itself when the transmission mode is the second transmission mode; if the value of the flag bit corresponding to itself is the first value, perform data operation, and after changing the value of the flag bit corresponding to itself to the second value, determine the fourth path with the shortest length among all paths from itself to all second node devices corresponding to the flag bit with the first value via the first direction and the second direction respectively, and transmit the bus signal 102 to the next second node device along the fourth path; if the value of the flag bit corresponding to itself is the second value, when the value of at least one flag bit among the N flag bits is the first value, transmit the bus signal to the next second node device along the same direction as the direction in which the bus signal 102 is received.

When broadcasting data, the M flag bits with the first value in the broadcast indicator correspond to the M target node devices. If path optimization is needed to improve transmission efficiency, the controller 100 only needs to configure one or more first control signals 101 for the first node device according to the situation. After the first node device receives the first control signal 101, it needs to perform M path planning on the M target node devices to find the shortest path among the 2M paths and send the bus signal 102 along the path to the next closest target node device. Then the next target node device needs to find the shortest path among the 2 (M-1) paths and send the bus signal 102 along the path, and the cycle continues until all M target node devices are broadcast.

As a specific example, assume that the controller 100 needs a node device 200-2 to broadcast data to the other four node devices 200-0, 200-1, 200-3 and 200-4 (as shown in FIG. 3, the node devices 200-0, 200-1, 200-2, 200-3 and 200-4 are configured in sequence on the ring). For convenience, assume that the path segments between all adjacent node devices 200 are equivalent, then the path optimization of broadcast data can be achieved in the following three ways.

### Method 1:

The controller divides the above four node devices into two groups, namely {200-0, 200-3} and {200-1, 200-4}. The rules for distinction are determined by the controller 100. A result of the distinction here is only an example.

The controller 100 primarily sends the first one first control signal 101 to the first node device. The value of the flag bit corresponding to the node devices 200-0 and 200-3 in the first control signal 101 is the first value, and the transmission mode is the second transmission mode. In response to the first control signal 101, the node device 200-2 generates the first bus signal 102, and performs path optimization for the node devices 200-0 and 200-3, and selects an optimal transmission path, that is, transmits to the node device 200-3 through the second direction P2. After receiving the bus signal 102, the node device 200-3 performs path optimization for the remaining node devices 200-0, and selects the second optimal transmission path, that is, transmits to the node device 200-0 through the first direction P1. The node device 200-0 receives the bus signal 102, which means that the broadcast is completed.

After the controller 100 determines that the transmission of the first bus signal 102 is completed (i.e., two judgments are required to determine that the node devices 200-0 and 200-1 are successfully broadcasted respectively, and the specific method of determining the successful transmission can be referred to step 8) in the specific process below), it sends a second first control signal 101 to the first node device, and the value of the flag bit corresponding to the node devices 200-1 and 200-4 in the first control signal 101 is the first value, and the transmission mode is the second transmission mode. The node device 200-2 generates the second bus signal 102 in response to the first control signal 101, and completes the broadcast to the node devices 200-1 and 200-4 in the same way as the broadcast to the node devices 200-0 and 200-3.

### Method 2:

The controller still divides the above four node devices 200 into two groups, namely {200-0, 200-3} and {200-1, 200-4};

The controller 100 simultaneously sends two first control signals 101 to the first node device. The value of the flag bit corresponding to the node devices 200-0 and 200-1 in one of the first control signals 101 is the first value, and the value of the flag bit corresponding to the node devices 200-3 and 200-4 in the other first control signal 101 is the first value, and the transmission mode is the second transmission mode. The node device 200-2 generates two bus signals 102 in response to the two first control signals 101 respectively. The transmission process of the two bus signals 102 is the same as the respective transmission process in method 1.

### Method 3:

The controller 100 does not group the above four node devices 200.

The controller 100 sends a first control signal 101 only to the first node device. The flag values corresponding to the node devices 200-0, 200-1, 200-3 and 200-4 in the first control signal 101 are the first values, and the transmission mode is the second transmission mode. In response to the first control signal 101, the node device 200-2 generates the first bus signal 102, and performs path optimization for the node devices 200-0, 200-1, 200-3 and 200-4, and selects an optimal transmission path (at this time, there are two optimal paths along the first direction P1 to the node device 200-1 and along the second direction P2 to the node device 200-3, and either one can be selected, that is, mode three further has two execution modes). Assume that the selected path is transmitted along the first direction P1 to the node device 200-1, after node device 200-1 receives bus signal 102, it performs path optimization for the remaining node devices 200-0, 200-3 and 200-4, and selects the second optimal transmission path, that is, transmits to node device 200-0 through the first direction P1, and then transmits to node device 200-3 along the second direction P2 in the same way, and transmits to node device 200-4 along the second direction P2. Node device 200-4 receives bus signal 102, which means that the broadcast is completed.

In the above embodiment and its three specific implementations, the difference is that the number and timing of the first control signal 101 sent by the controller 100 to the first node device are different, but the rules for the first node device to respond to the first control signal 101 and the rules for each second node device to respond to the bus signal 102 are the same. In this way, it is only necessary to configure the controller 100 to select a specific way to send the first control signal 101, without overly complex configuration of the node device 200, which helps to reduce the complexity of the entire topological circuit 1000.

The controller 100 can select a specific method for optimizing the path of broadcast data according to its own situation. For example, if it is necessary to save power consumption, the method 3 that only needs to configure the first control signal 101 once can be selected; for another example, if it is necessary to pursue performance, the method 2 can be selected to send multiple first control signals 101 at the same time and then broadcast data in parallel, and so on.

In some other embodiments, the loop of the topological circuit 1000 is a bidirectional loop, and the first node device is configured to: when the transmission mode is the second transmission mode, determine the first sum of the lengths of all paths from the first node device via the first direction P1 to all second node devices corresponding to the flag bit with the first value, and the second sum of the lengths of all paths from the first node device via the second direction P2 to all second node devices corresponding to the flag bit with the first value; if the first sum is less than the second sum, the bus signal 102 is transmitted along the first direction P1; and if the first sum is greater than the second sum, the bus signal 102 is transmitted along the second direction. And the second node device is configured to: when transmitting the bus signal 102 along the loop to the next second node device, transmit the bus signal in the same direction as the direction in which the bus signal 102 is received.

The above embodiment provides another rule for the first node device to respond to the first control signal 101 and each second node device to respond to the bus signal 102 in the scenario of broadcast data using path optimization. A specific example under this rule is given below:

Suppose the controller 100 requires a node device 200-2 to broadcast data to another three node devices 200-0, 200-1 and 200-4 (see FIG. 3). For convenience, assume that the path segments between all adjacent node devices 200 are equivalent, and the controller 100 does not group the above three node devices, and N=5 in FIG. 3, that is, there are a total of 6 node devices 200. Under this rule:

The controller 100 sends a first control signal 101 to the node device 200-2, and the value of the flag bit corresponding to the node devices 200-0, 200-1 and 200-4 in the first control signal 101 is the first value, and the transmission mode is the second transmission mode. The node device 200-2 generates a first bus signal 102 in response to the first control signal 101, and calculates a first sum (2+1+4=7) of the lengths of the three paths along the first direction P1 to the three node devices 200-0, 200-1 and 200-4, and a second sum (4+5+2=11) of the lengths of the three paths along the second direction P2 to the three node devices 200-0, 200-1 and 200-4. According to the first sum being less than the second sum (if the first sum is equal to the second sum, both the first direction P1 and the second direction P2 can be selected as a further execution mode), the bus signal 102 is selected to be transmitted along the first direction P1, and the bus signal is sequentially transmitted to the node device 200-1, the node device 200-0 and the node device 200-4 along the first direction P1. The node device 200-4 receives the bus signal 102, which means that the broadcast is completed.

In the above embodiment, in the scenario of broadcast data with path optimization, the rules for the first node device to respond to the first control signal 101 and the second node devices to respond to the bus signal 102 are different from the rules given above. That is, the controller can not only choose the way to configure the first control signal 101 according to its own situation, but also configure different response rules for the node device 200, which increases the functional flexibility of the topological circuit 1000.

In some embodiments, in addition to the various sub-signals given above, the bus signal 102 also includes one or more sub-signals of the command valid indicator (vld), transmission data (dat), ready indicator (rdy), transmission start (sop) and transmission end (eop). Based on FIG. 3, the following is a specific process example of point-to-point transmission between adjacent node devices 200.
0) The controller 100 requires the node device 200-1 (address 0x0) to move 1 MB of data from the offset address of 0x40 to the offset address of 0x80 of the adjacent node device 200-2 (address 0x4000). The node device 200-1 is the first node device and the node device 200-2 is the second node device.
1) The controller 100 sends a first control signal 101 to the node device 200-1. The first control signal 101 includes:
   a. The address of the node device 200-1 plus its offset address as the starting address: 0x0+0x40;
   b. The address of the node device 200-2 plus its offset address as the target address: 0x4000+0x80;
   c. The data size is 1 MB;
   d. The transmission mode is point-to-point transmission, and the transmission option is write transmission or read transmission.
2) Node device 200-1 converts the first control signal 101 into a bus signal 102. In the case of write transmission, according to the bus width 64B, it is concluded that the bus signal 102 needs to be transmitted 1 MB/64B=16384 times (in the case of read transmission, node device 200-2 is required to calculate the number of transmissions).

The subsequent process of write transmission is as follows:
3) Node device 200-1 uses the first bus 200-12 as the request (req) channel and sends the first request bus signal 102, where req_vld and req_sop (the sub-signal prefix contains req, which means it is sent on the req channel, and the same meaning is used below) are set high, req_dat contains the 64B data of the first transmission, op is 0 for write, mode is 1 for point-to-point transmission, addr is 0x80, size is 0xF_FFFF (1 MB-1B), indicator can be set arbitrarily because mode is 1, req_src_id is 0x1, indicating node device 200-1 itself, req_dst_id indicates node device 200-2, and the remaining sub-signals are set low or contain no content.
4) Node device 200-2 receives the bus signal 102 of the first request, determines that it is the target node device according to req_dst_id, determines that it is the first transmission according to the high req_sop, writes the data contained in req_dat to the offset address corresponding to addr for the first time, and then uses the second bus 200-21 as the response (rsp) channel to send the bus signal 102 of the first response, in which req_vld and req_sop are set low, req_rdy is set high, and the other sub-signals are set low or contain no content, and its own address counter is incremented by 1.
5) Node device 200-1 receives the bus signal 102 of the first response, and determines that the bus signal 102 of the first request and the 64B data contained therein are successfully received by node device 200-2 according to the high req_rdy, the first data transmission is completed, and its own address counter is incremented by 1.
6) Repeat steps 3), 4) and 5) 16384-1 times, req_sop is set low in each step 3), and req_eop is set high in the last step 3). In the last step 4), the node device 200-2 determines that this transmission is the last transmission based on the high req_eop, and clears its own address counter after sending the last response bus signal 102 on the second bus 200-21. In the last step 5), the node device 200-1 verifies that the last request bus signal 102 and the 64B data contained therein have been successfully received, and clears its own address counter.
7) Node device 200-2 gives the value of req_src_id to rsp_dst_id, and the value of req_dst_id to rsp_src_id, and actively sends bus signal 102 to node device 200-1 through the second bus 200-21, in which rsp_sop and rsp_eop are set high, and rsp_dat contains information indicating successful transmission. In some embodiments, the information indicating successful transmission is not carried in rsp_dat, but an additional piece of information can be transmitted.
8) There are two ways to notify the controller 100 that the transmission is completed. Method 1 is active notification: Node device 200-1 sends an interrupt signal to the controller 100 to inform the completion of the transmission based on the received rsp_cop set high. Method 2 is passive notification: After receiving the rsp_cop set high, the node device 200-1 stores the signal bit indicating the completion of the transmission in its own register, waiting for the controller 100 to read it. After the controller 100 reads it, it is notified that the transmission is completed.

Subsequent process of read transmission:
3′) Node device 200-1 uses the first bus 200-12 as the request (req) channel and sends out the bus signal 102 of the first request, in which req_vld, req_sop and req_cop are set high, req_dat does not contain specific data because it is reading data, op is 1 for reading, mode is 1 for point-to-point transmission, addr is 0x80, size is 0xF_FFFF (1 MB-1B), indicator can be set arbitrarily because mode is 1, req_src_id is 0x1 for node device 200-1 itself, req_dst_id for node device 200-2, and the remaining sub-signals are all set low or contain no content.
4′) Node device 200-2 receives the bus signal 102 of the first request, determines itself as the target node device according to req_dst_id, and determines it as the first transmission according to the high req_sop. Then, the value of req_src_id is given to rsp_dst_id, and the value of req_dst_id is given to rsp_src_id, and the second bus 200-21 is used as the response (rsp) channel to actively send the first response bus signal 102, in which req_vld, req_sop and req_cop are set low, req_rdy is set high, and the 64B data starting from addr is put into rsp_dat for the first time according to op being 1. Since the response bus signal 102 contains data, rsp_vld and rsp_sop are set high, and the other sub-signals are all set low or contain no content.
5′) Node device 200-1 receives the first active response bus signal 102, and judges that the first request bus signal 102 is successfully received by node device 200-2 according to the high req_rdy, and judges that the bus signal 102 is the response signal actively sent by node device 200-2 according to the high rsp_vld, and writes the data contained in rsp_dat to its own offset address for the first time according to the high rsp_sop. Then, the first bus 200-12 is used as the response channel for node device 200-2, and the first bus signal 102 responding to node device 200-2 is sent, in which rsp_vld and rsp_sop are set low, rsp_rdy is set high, and the other sub-signals are all set low or contain no content, and its own address counter is incremented by 1.
6′) Node device 200-2 receives the first bus signal 102 in response to it, and judges that the first active response bus signal 102 and the 64B data contained therein are successfully received by node device 200-1 according to the high rsp_rdy, the first data transmission is completed, and its own address counter is increased by 1.
7′) Repeat steps 4′), 5′) and 6′) 16384-1 times, rsp_sop is set low in each step 4′), and rsp_eop is set high in the last step 4′). In the last step 5′), node device 200-1 judges that this transmission is the last transmission according to the high rsp_eop, and after sending the last bus signal 102 in response to node device 200-2 on the first bus 200-12, its own address calculator is cleared. In the last step 6′), node device 200-2 verifies that the last active response bus signal 102 and the 64B data contained therein are successfully received, and then clears its own address counter.
8′) Node device 200-2 does not need to give the value of req_src_id to rsp_dst_id or the value of req_dst_id to rsp_src_id, and actively sends bus signal 102 to node device 200-1 through second bus 200-21, rsp_sop and rsp_eop are set high, and rsp_dat contains information indicating successful transmission;
9′) Notify controller 100 that the transmission is completed, there are two ways. Mode 1 is active notification: node device 200-1 sends an interrupt signal to controller 100 to inform that the transmission is completed according to the second reception of the high rsp_eop; Mode 2 is passive notification: node device 200-1 stores the signal bit indicating the completion of the transmission in its own register after receiving the high rsp_eop for the second time, and waits for controller 100 to read it. After controller 100 reads it, it is notified that the transmission is completed.

In some embodiments, controller 100 is a general-purpose processor (e.g.CPU) and N node devices 200 are accelerated processing units (e.g.NPU). In this way, the advantages of NPU such as large amount of data calculation and fast speed can be used to assist CPU to perform various tasks.

The present application also provides an artificial intelligence chip, which includes the topological circuit 1000 in any of the above embodiments, and its technical effects have been described above and will not be repeated here.

The present application also proposes a data transmission method, which is executed based on the topological circuit 1000 in any of the above embodiments. The method comprises: the controller 100 sends the first control signal 101; in response to receiving the first control signal 101, the first node device converts the first control signal 101 into the bus signal 102 and transmits the bus signal 102 along the loop; and in response to receiving the bus signal 102, each second node device performs a corresponding operation according to the bus signal 102. The various technical effects related to the method can refer to the above description and will not be repeated here.

So far, the various embodiments of the present application have been described in detail. In order to avoid obscuring the concept of the present application, some details known in the art are not described. Based on the above description, those skilled in the art can fully understand how to implement the technical solution disclosed here.

Although some specific embodiments of the present application have been described in detail by way of examples, it should be understood by those skilled in the art that the above examples are for illustration only and are not intended to limit the scope of the present application. It should be understood by those skilled in the art that the above embodiments may be modified or some technical features may be replaced by equivalents without departing from the scope and spirit of the present application. The scope of the present application is defined by the appended claims.

What is claimed is:

1. A topological circuit, comprising:
a controller, configured to send a first control signal; and
N node devices, respectively connected to the controller, N>2, wherein the N node devices are connected in a ring via a bus to form a loop, and the N node devices include:
a first node device, configured to: convert the first control signal into a bus signal in response to receiving the first control signal, and transmit the bus signal along the loop, wherein the bus signal comprises a transmission option and a broadcast indicator, the transmission option is one of a read transmission and a write transmission, the broadcast indicator comprises N flag bits corresponding to the N node devices one by one, each flag bit has a first value or a second value, the first value indicates that a data operation corresponding to the transmission option needs to be performed, and the second value indicates that the data operation does not need to be performed, and
N-1 second node devices, each second node device is configured to perform a corresponding operation according to the bus signal in response to receiving the bus signal.

2. The topological circuit according to claim 1, wherein
the bus signal further comprises a transmission mode and a destination identifier, the transmission mode is a first transmission mode corresponding to the destination identifier or a second transmission mode corresponding to the broadcast indicator; and
each second node device is configured to perform a corresponding operation according to the transmission mode in response to receiving the bus signal.

3. The topological circuit according to claim 2, wherein each second node device is configured to:
if the transmission mode is the first transmission mode, verify whether the destination identifier corresponds to itself, wherein
if the destination identifier corresponds to itself, perform the data operation;
if the destination identifier does not correspond to itself, transmit the bus signal along the loop to the next second node device.

4. The topological circuit according to claim 2, wherein each second node device is configured to:
if the transmission mode is the second transmission mode, verify a value of a flag bit corresponding to itself;
if a value of a flag bit corresponding to itself is the first value, perform the data operation, and after changing the value of the flag bit corresponding to itself to the second value, transmit the bus signal along the loop to a next second node device;
if a value of a flag bit corresponding to itself is the second value, when the value of at least one of the N flag bits is the first value, transmit the bus signal along the loop to a next second node device.

5. The topological circuit according to claim 4, wherein each second node device is configured to:
when all the N flag bits are the second value, stop transmitting the bus signal.

6. The topological circuit according to claim 1, further comprising:
one or more groups of selectors, one group of selectors corresponds to one node device, at least one group of selectors includes a first subgroup of selectors, and the first subgroup of selectors is configured to control whether the bus signal transmitted along a first direction skips a corresponding node device.

7. The topological circuit according to claim 6, wherein the loop is a bidirectional loop,
at least one group of selectors includes a second subgroup of selectors, and the second subgroup of selectors is configured to control whether the bus signal along a second direction skips the corresponding node device, and the second direction is different from the first direction.

8. The topological circuit according to claim 7, wherein at least one group of the selectors includes the first subgroup of selectors and the second subgroup of selectors.

9. The topological circuit according to claim 7, wherein the first subgroup of selectors and the second subgroup of selectors each include a first selector and a second selector, wherein in each subgroup of selectors:
the first selector comprises:
a first input terminal, connected to a former node device of the corresponding node device,
a first output terminal, connected to the corresponding node device, and
a second output terminal;
the second selector comprises:
a second input terminal, connected to the second output terminal,
a third input terminal, connected to the corresponding node device, and
a third output terminal, connected to a latter node device of the corresponding node device.

10. The topological circuit according to claim 6, wherein the one or more groups of selectors include N groups of selectors.

11. The topological circuit according to claim 6, wherein
the controller is further configured to: send a second control signal to each group of selectors to control each group of selectors to control whether the bus signal skips the corresponding node device.

12. A topological circuit according to claim 6, wherein
the first subgroup of selectors corresponding to a specific node device among the N node devices are configured to control the bus signal transmitted along the first direction to skip the specific node device, and the specific node device includes a faulty node device or a node device shut down.

13. A topological circuit according to claim 2, wherein the loop is a bidirectional loop, and the first node device is configured to:
when the transmission mode is the first transmission mode, determine a length of a first path and a length of a second path from the first node device to a target node device corresponding to the destination identifier via a first direction and a second direction respectively;
if the length of the first path is less than the length of the second path, transmit the bus signal along the first direction;
if the length of the first path is greater than the length of the second path, transmit the bus signal along the second direction.

14. The topological circuit according to claim 2, wherein the loop is a bidirectional loop, and the first node device is configured to:
on condition that the transmission mode is the second transmission mode, determine a third path with the shortest length among all paths from the first node device to all second node devices corresponding to a flag bit whose value is the first value via a first direction and a second direction respectively; and
transmit the bus signal along the third path.

15. The topological circuit according to claim 14, wherein each second node device is configured to:
on condition that the transmission mode is the second transmission mode, verify a value of a flag bit corresponding to itself;
if the value of the flag bit corresponding to itself is the first value, perform the data operation, and after changing the value of the flag bit corresponding to itself to the second value, determine a fourth path with the shortest length among all paths from itself to all second node devices corresponding to a flag bit whose value is the first value via the first direction and the second direction respectively, and transmit the bus signal to a next second node device along the fourth path; and
if the value of the flag bit corresponding to itself is the second value, when a value of at least one flag bit among the N flag bits is the first value, transmit the bus signal to a next second node device along the same direction as a direction in which the bus signal was received.

16. The topological circuit according to claim 4, wherein the loop is a bidirectional loop,
and the first node device is configured to:
on condition that the transmission mode is the second transmission mode, determine a first sum of lengths of all paths via a first direction from the first node device to all second node devices corresponding to a flag bit whose value is the first value, and a second sum of lengths of all paths via a second direction from the first node device to all second node devices corresponding to a flag bit whose value is the first value;
if the first sum is less than the second sum, transmit the bus signal along the first direction; and
if the first sum is greater than the second sum, transmit the bus signal along the second direction; and
the second node device is configured to:
transmit the bus signal along the same direction as a direction in which the bus signal is received, when transmitting the bus signal along the loop to a next second node device.

17. The topological circuit according to claim 5, wherein the loop is a bidirectional loop,
and the first node device is configured to:
on condition that the transmission mode is the second transmission mode, determine a first sum of lengths of all paths via a first direction from the first node device to all second node devices corresponding to a flag bit whose value is the first value, and a second sum of lengths of all paths via a second direction from the first node device to all second node devices corresponding to a flag bit whose value is the first value;
if the first sum is less than the second sum, transmit the bus signal along the first direction; and
if the first sum is greater than the second sum, transmit the bus signal along the second direction; and
the second node device is configured to:
transmit the bus signal along the same direction as a direction in which the bus signal is received, when transmitting the bus signal along the loop to a next second node device.

18. A topological circuit according to claim 1, wherein the controller is a general-purpose processor and the N node devices are accelerated processors.

19. An artificial intelligence chip, comprising the topological circuit according to claim 1.

20. A data transmission method, based on the topological circuit according to claim 1, comprising:
the controller sends the first control signal;
in response to receiving the first control signal, the first node device converts the first control signal into a bus signal, and transmits the bus signal along the loop; and
in response to receiving the bus signal, each second node device performs a corresponding operation according to the bus signal.
